(19) United States
(12) Patent Application Publication
(10) Pub. No.: US 2005/0125343 A1
(43) Pub. Date: Jun. 9, 2005

(54) Method and apparatus for monetizing personal consumer profiles by aggregating a plurality of consumer credit card accounts into one card

(76) Inventor: Isaac F. Mendelovich, Elkins Park, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 11/004,552

(22) Filed: Dec. 3, 2004

Related U.S. Application Data
(60) Provisional application No. 60/526,765, filed on Dec. 3, 2003.

(51) Int. Cl. G06F 17/60

(52) U.S. Cl. 705/39

(57) ABSTRACT

A computer-implemented method of using one of a plurality of existing credit card accounts belonging to a consumer includes providing account data to a single service provider for a plurality of existing credit card accounts belonging to the consumer and providing the consumer with a compilation credit card associated with the plurality of existing credit card accounts of the consumer. the method also includes storing predefined preferences of the consumer regarding credit card selectivity, the consumer performing a credit card transaction and selecting one existing credit card account among the plurality of existing credit card accounts to which to charge the credit card transaction based on the stored predefined preferences of the consumer.

### CROSS-REFERENCE TO RELATED APPLICATIONS

This application claims priority to U.S. Provisional Patent Application No. 60/526,765, filed Dec. 3, 2003, entitled “Method and Apparatus for Monetizing Personal Consumer Profiles by Aggregating a Plurality of Consumer Credit Card Accounts into One Card.”

### BACKGROUND OF THE INVENTION

The present invention relates to a method and apparatus for monetizing personal consumer profiles, and more particularly to a method and apparatus for monetizing personal consumer profiles by aggregating a plurality of consumer credit card accounts into one card.

In the United States, the typical consumer holds three or more credit card accounts. Many credit card companies offer “cash back” and an opportunity to earn free air travel by accumulating points or “flyer miles” based on the amount the consumer charges on the companies' credit cards. Some credit card companies hold special promotions during the year whereby the consumer is eligible to double or triple the usual number of points or cash back earned per dollar charged on the card. It is difficult for the consumer to remember and keep track of the types of promotions and rewards that the consumer's credit cards provide.

Credit card experts suggest that consumers should carry only those credit cards that they plan to use and leave the other ones at home. Additionally, experts suggest that consumers should familiarize themselves with the credit limits, interest rates and benefits provided by each credit card used to enable the consumers to reap the best rewards while minimizing the cost of using credit cards.

Furthermore, carrying too many credit cards can make it difficult for the consumer to keep track of them. Having a wallet full of credit cards is risky because it is easy to lose one and the consumer may not even realize that it is missing until it is too late. The event of losing a credit card turns a fun time into a stressful situation rather quickly.

FIG. 1 shows a conventional credit card transaction system 100. When a consumer desires to carry out a credit card transaction in order to purchase a product or service provided by a vendor, a vendor transaction system 105 is used to transmit credit card account and transaction information over a network 110 to one of a plurality of credit card companies 115, 120, 125, 130 that process the transaction and authorize or decline the transaction. The vendor uses a card reader 135 to read information from a magnetic strip on the surface of a credit card 140 presented by the consumer. If the consumer has more than one credit card in his or her possession, the consumer must decide which credit card should be used. Since more than 50% of all consumers pay off their credit card bills each month and have good credit, the credit limit of the different credit cards does not play an important factor in making such a decision, especially in today's credit industry environment where it is not uncommon for individual credit card companies to offer credit lines of $10,000 or more. Many credit cards offer perks, e.g., free airline travel, cash back, or the like. Consumers who have a plurality of cards may find it difficult to remember which card provides a particular perk, and consumers may not be aware of special premium promotions offered by credit card companies at certain times of the year.

It would be advantageous for a consumer to be able to register and access any one of a plurality of the consumer's credit card accounts through the use of a single card (hereinafter referred to as “compilation card”). Furthermore, it would be desirable to automatically determine the best credit card account to use for each charge transaction based on the consumer's preferences/criteria by establishing a personal profile that is referenced each time the compilation card is used. Additionally, it would be desirable to generate more competition among credit card companies by leveraging the consumer's negotiating powers and thus enticing the credit card companies to provide better rewards and benefits to the consumer for using their credit cards while providing the credit card companies with a larger customer base.

It would also be desirable to maintain the privacy of the consumer's identity and the security of the consumer's credit card transactions. It would also be desirable to establish a backup system for enabling the consumer to carry out transactions with the compilation card even if the compilation card service provider was not accepted by the vendor or was temporarily disabled.

It would also be desirable to give the consumer an opportunity to earn extra income by providing a user-friendly forum for the consumer to receive a share of revenue generated by a compilation card service provider that manages the consumer's credit card transactions and offers merchants access to the consumer's personal information maintained in the consumer's personal profile or elsewhere, in whole or in part. It would also be desirable to give the consumer the power to demand specific levels of compensation for providing the personal information. It would also be desirable to expand the opportunity for merchants to attract new customers by providing a portal that draws consumers and provides a medium for merchants to entice the consumers with offers.

### SUMMARY OF THE INVENTION

Briefly stated, the present invention comprises a method and apparatus for using a single credit card (a “compilation card”) to access one of a plurality of credit card accounts belonging to a consumer and to select which credit card account to charge a transaction to based on a profile of the consumer's preferences and criteria stored in a database. The present invention uses artificial intelligence (AI) to automatically determine, based on the consumer's preferences/criteria and the rewards made available by credit card companies associated with the consumer's credit card accounts, which of the consumer's existing credit card accounts is to be used for a specific transaction.

The present invention comprises a computer-implemented method of using one of a plurality of existing credit card accounts belonging to a consumer includes providing account data to a single service provider for a plurality of existing credit card accounts belonging to the consumer and providing the consumer with a compilation credit card associated with the plurality of existing credit card accounts of the consumer. the method also includes storing predefined preferences of the consumer regarding credit card selectivity, the consumer performing a credit card transaction and selecting one existing credit card account among the plurality of existing credit card accounts to which to charge the credit card transaction based on the stored predefined preferences of the consumer.

The present invention also comprises an apparatus that permits a consumer to access one of a plurality of existing credit card accounts belonging to the consumer. The system includes at least one credit card transaction network configured to route credit card transactions and a compilation credit card being associated with the plurality of existing credit card accounts of the consumer. The compilation credit card has a compilation credit card number associated therewith. The system also includes a compilation card service provider having a compilation card database that stores information for the plurality of existing credit card accounts belonging to the consumer and a consumer preferences database that stores predefined consumer preferences of the consumer. The compilation card service provider has access to the plurality of existing credit card accounts of the consumer, and the compilation card service provider is accessible by the at least one credit card transaction network to receive credit card transaction requests based on the compilation credit card number and is configured to send credit card transaction approvals/denials. One of the compilation credit card and the compilation card service provider is configured to select one existing credit card account among the plurality of existing credit card accounts to which to charge a particular credit card transaction based on the predefined preferences of the consumer.

In one embodiment of the present invention, a compilation card service provider is authorized by the consumer to act on the consumer's behalf (e.g., as a broker, agent, back office, or the like). The compilation card service provider intercepts each of the consumer's credit card transactions made using the compilation card, selects the consumer's credit card account that best meets the consumer's previously selected preferences/criteria, and forwards the account number and expiration date of the selected credit card account, and any other information required to complete the transaction, to the credit card company associated with the selected account. The compilation card service provider keeps track of information associated with rewards offered by credit card companies on a continuous basis. The compilation card service provider then uses artificial intelligence for each compilation card transaction to correlate the reward information with the consumer's account number and selected preferences/criteria. The compilation card service provider enables the consumer to update/change data stored in the consumer's profile.

In another embodiment of the present invention, the compilation card service provider enables the consumer to designate compensation levels required before merchants, credit card companies, or the like, are granted access to all or part of personal information stored in the consumer's profile or elsewhere.

In another embodiment of the present invention, the compilation card service provider enables the consumer to screen which type of offers the consumer is interested in and is willing to receive via e-mail. The compilation card service provider also enables the consumer to designate compensation levels required before e-mail messages will be accepted for delivery, and the consumer may specify different “prices” for different types of e-mail messages.

In another embodiment of the present invention, the compilation card is a secured smart card that includes an account number but does not include the name of the consumer on the surface of the compilation card. A “smart chip” or other intelligent device within the card is used to validate the authority of the user of the compilation card while maintaining the consumer's privacy. The secured smart card may store personal information about the consumer, such as information related to the consumer's health, driving record, financial, work, computer access (e.g., passwords), etc. The smart chip provides a default credit card account number when inserted in a card reader in the unlikely event that the compilation card service provider is disabled, or if the merchant refuses or is unable to execute compilation card transactions.

In another embodiment of the present invention, the compilation card service provider establishes a debit card account, separate from any of the consumer's credit card accounts, in which earned rewards are saved and redeemed. The compilation card can also serve as a debit card to redeem accumulated rewards earned from the consumer accessing particular credit card accounts using the compilation card. The compilation card service provider can also convert or exchange non-cash rewards, such as frequent flyer miles, into cash which can then be accessed through an ATM or used as a method of payment for merchandise at a premium exchange rate over the Internet or when visiting a merchant.

In another embodiment of the present invention, a compilation card service provider portal attracts new customers for merchants by providing convenient and extensive benefits. Merchants benefit by being exposed to a large consumer base, which enhances their chances of procuring new customers.

### BRIEF DESCRIPTION OF THE SEVERAL VIEWS OF THE DRAWING

The following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram of a conventional credit card transaction management system;

FIG. 2 is an exemplary top plan view of a compilation card in accordance with a first preferred embodiment of the present invention;

FIG. 3 is a diagram of an apparatus used to implement compilation card transactions in accordance with a second preferred embodiment of the present invention;

FIG. 4 is a consumer credit card correlation database in accordance with the preferred embodiments of the present invention;

FIG. 5 is a flow chart illustrating a credit card transaction method implemented by the apparatus of FIG. 3 in accordance with the preferred embodiments of the present invention; and

FIG. 6 is a diagram of a communications device including a smart chip that executes credit card transactions with a vendor in accordance with embodiments of the present invention.

### DETAILED DESCRIPTION OF THE INVENTION

Certain terminology is used in the following description for convenience only and is not limiting. “Compilation” refers to combining, gathering and/or aggregating a plurality of different sources and/or a collection of sources. “Credit card” includes any one or more of a credit card, a charge card, a check card, a debit card, a stored value card, a phone card and an automated teller machine (ATM) card. “Artificial intelligence” as used herein may include an expert system, fuzzy logic, a neural network(s), a comparison lookup table(s), weighted or un-weighted usage averaging, a decision tree(s), a software program and the like. Additionally, the word “a”, as used in the claims and in the corresponding portions of the specification, means “at least one.”

To implement the present invention, a system and method is implemented for monetizing personal consumer profiles by aggregating a plurality of consumer credit card accounts into a compilation card, i.e., a single card—similar to a conventional credit card 140—having a plurality of pre-existing consumer accounts associated therewith.

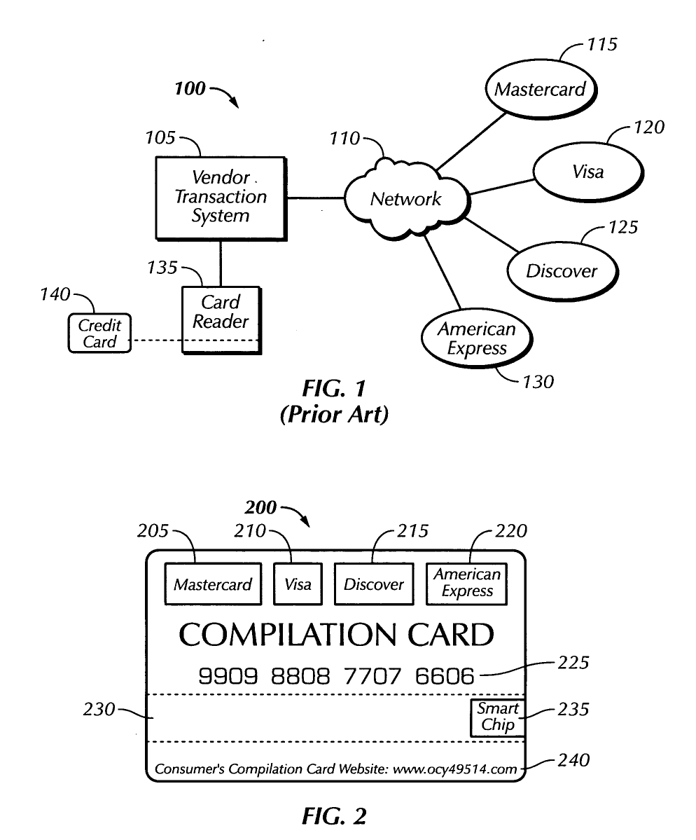

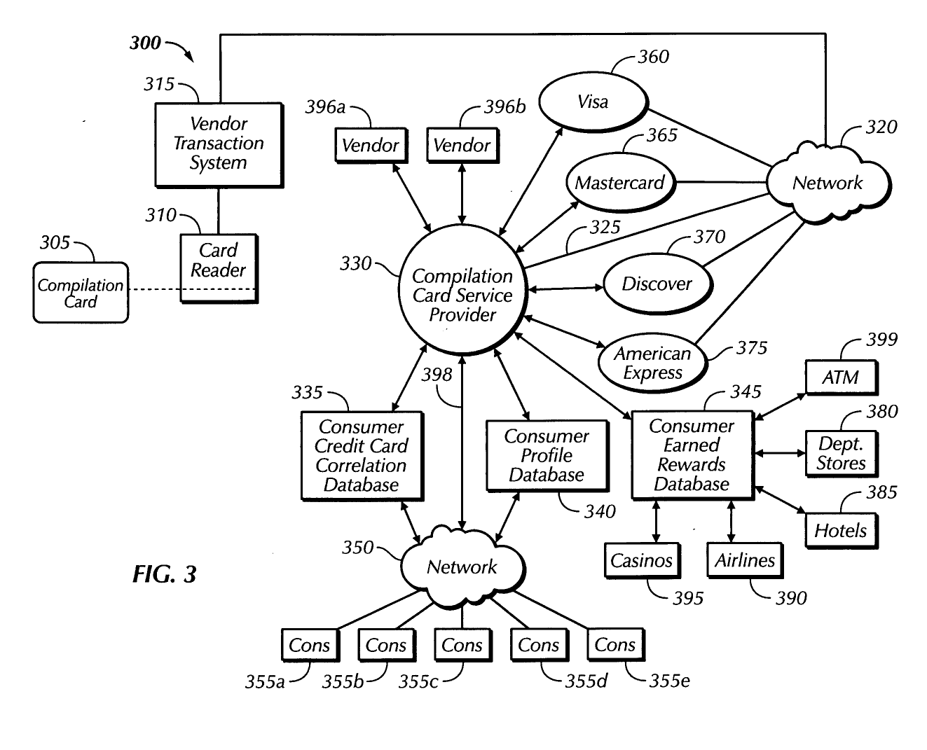

FIG. 2 shows a compilation card 200, in accordance with a first preferred embodiment of the present invention, that is obtained by a consumer 355a-355e (FIG. 3) applying for and providing information to a compilation card service provider (like 330 in FIG. 3). The application process may be carried out over the Internet, via telephone, by mail, in person, or by any other well known communications means. The compilation card service provider may charge the consumer 355a-355e a fee, but it is anticipated that, at least initially, the compilation card 200 would be provided at no cost to the consumer 355a-355e. The compilation card may be structured as a club providing benefits to its members (subscribers).

The compilation card 200 enables the consumer 355a-355e to access any one of a plurality of credit card accounts for which the consumer 355a-355e has already been approved and has already received separate individual credit cards 140. The compilation card 200 does not interfere with the use of the individual credit cards 140, which can be used independently of the compilation card 200 at any time desired by the consumer 355a-355e. The compilation card 200 is not a credit card, per se, but a means for accessing the consumer's existing credit card accounts to carry out credit card transactions using one of the account numbers associated with the existing accounts.

The compilation card 200, in conjunction with the compilation card service provider 330, acts as an intermediary to determine which of the consumer's plural (existing) credit card accounts, that are registered with the compilation card service provider 330, should be used to carry out a particular credit card transaction based on a consumer profile established by the consumer 355a-355e. The compilation card service provider 330, itself, does not take a financial risk in extending credit to the consumer 355a-355e, as this risk is borne by the credit card companies that provide the consumer 355a-355e with credit card accounts. The compilation card 200 provides consumers 355a-355e convenience, time and money savings, security and an opportunity to generate extra cash. The compilation card 200 provides consumers 355a-355e the opportunity to redeem rewards at a premium exchange rate through special deals negotiated by the compilation card service provider 330 on behalf of the consumers 355a-355e.

The compilation card 200 preferably has emblems representing various credit card companies such as MasterCard® 205, Visa® 210, Discover® 215, American Express® 220 on the surface of the card 200 that have previously extended credit and supplied credit card accounts to the consumer 355a-355e and that the compilation card service provider 330 can access on behalf of the consumer 355a-355e. Visa is a registered service mark of Visa International Service Association, Foster City, Calif.; MasterCard is a registered service mark of MasterCard International Incorporated, Purchase, N.Y.; Discover is a registered service mark of NOVUS Credit Services Inc., Riverwoods, Ill.; and American Express is a registered service mark of American Express Company, New York, N.Y. The emblems 205, 210, 215, 220 may be customized for each individual consumer 355a-355e based on the particular existing credit card accounts that the consumer 355a-355e has registered with the compilation card service provider 330, or the emblems may be generic in that they simply represent those companies that the compilation card service provider 330 carries out credit card transactions with, irrespective of which accounts a given consumer 355a-355e actually has preconfigured. Below the emblems 205, 210, 215, 220 is the name of the compilation card 200 and/or the compilation card service provider 330, which may vary if more than one service provider or different types of the compilation card 200 are established, and a compilation card account number 225. The compilation card account number 225 serves as a trigger to direct credit card transactions associated with the use of the compilation card 200 to the compilation card service provider 330. The compilation card 200 also includes a magnetic stripe or strip (“mag-stripe”) 230 on the surface of the card, and a “smart chip” 235 to provide security features.

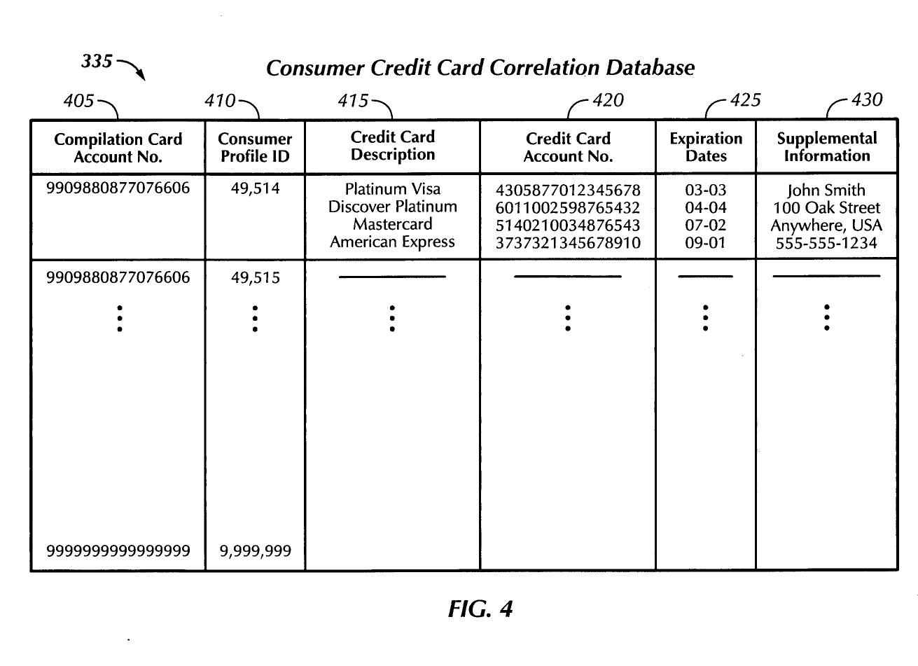

The mag-strip 230 includes data such as an American Banking Association (ABA) banking identification number (BIN) which provides routing instructions for data through a banking or other dedicated transaction network (such as network 320 in FIG. 4). It is contemplated that the mag-strip 230 may include all of the necessary data for a transaction request thereby negating the need for the smart chip 235. However, the compilation card 200 is preferably a smart card having a smart chip 235.

The compilation card 200 is a secured smart card that does not include a visible indication of the consumer's name on the surface of the card. The consumer's identity is validated through the use of the smart chip 235 while maintaining the privacy of the identity of the consumer 355a-355e. The smart chip 235 may incorporate or operate in conjunction with other security features, such as an image of the consumer 355a-355e using the card, fingerprint validation, personal identification number (PIN) code, passwords, or the like. The smart chip 235 may also contain information associated with the consumer's existing credit card accounts and sufficient artificial intelligence required to select one of the accounts to charge a transaction made using the compilation card 200. For example, the smart chip 235 may include a default credit card account number to charge a transaction when the compilation card service provider 330 is inoperable or when the vendor is unable or does not desire to use the compilation card service provider 330. Thus, the compilation card 200 can be used independently of the compilation card service provider 330 to partially provide some benefit to the consumer 355a-355e. The smart chip 235 may also store personal information about the consumer 355a-355e, such as information related to the consumer's health, driving record, financial data, work identification and/or data, computer access (e.g., passwords), etc., which can be accessed with the authorization of the consumer 355a-355e.

The compilation card 200 also provides website information 240, which identifies a website assigned to the individual consumer 355a-355e at which a vendor may obtain marketing information about the consumer 355a-355e, preferably at a cost specified by the consumer 355a-355e.

FIG. 3 shows a compilation card system or an compilation card apparatus 300 for implementing the features of a compilation card 305 in accordance with a second preferred embodiment of the present invention, similar to the compilation card 200 described above. The compilation card apparatus 300 includes a card reader 310 (e.g., a point-of-sale or POS terminal), a vendor transaction system 315, and a network 320. The network 320 maybe connected directly to a compilation card service provider 330 via path 325. The compilation card service provider 330 may alternatively be connected to the network 320 through another intermediary provider or through other intermediary providers such as banks or transaction processors (i.e., hosting providers).

The compilation card service provider 330 is connected to a consumer credit card correlation database 335, a consumer profile database 340 and a consumer earned rewards database 345. Databases 335, 340 and 345 are illustrated as being separate from the compilation card service provider 330. However, these databases 335, 340, 345 can, and likely will, reside within systems of the compilation card service provider 330, and thus may functionally operate together as a single unit. The consumer credit card correlation database 335 and the consumer profile database 340 are connected to the Internet 350 to permit compilation card consumers 355a-355e to access the databases 335, 340 and add or delete information used by the compilation card service provider 330 to make intelligent decisions regarding which one of a plurality of credit card accounts for each compilation card consumer 355a-355e should be used to carry out a particular transaction. All features and benefits of each consumer's registered credit card accounts, such as interest rates, rewards, special perks, or the like, are automatically incorporated by the compilation card service provider 330 into each intelligent decision. The decision making process is transparent to both the consumer 355a-355e and the merchant. The decision making process automatically incorporates principles and guidelines that were previously designated by the consumer 355a-355e and stored in the consumer profile database 340. The databases 335, 340 are also used by the compilation card service provider 330 to determine whether certain personal information associated with the consumer 355a-355e should be provided to a merchant, and at what price it should be provided.

Referring again to FIG. 3, the compilation card service provider 330 is also connected to a plurality of credit card companies 360, 365, 370, 375 that provide credit card accounts to the consumer 355a-355e and authorize transactions using associated credit card account numbers such as Visa 360, MasterCard 365, Discover 370 and American Express 375. The credit card companies 360, 365, 370, 375 are also directly connected to network 320, and thus credit card transactions that do not use the compilation card 305 are routed directly to the credit card company associated with the credit card used 360, 365, 370 or 375. Of course, various banks may provide credit cards such as their own version of MasterCard or Visa cards, as well.

The consumer earned rewards database 345 maintains up-to-date information on rewards earned by the consumer 355a-355e accessing registered credit card accounts through the use of the compilation card 305. The consumer rewards database 345 may be accessed by vendors such as department stores 380, hotels, 385, airlines 390, and casinos 395 for redemption of the rewards by the consumer 355a-355e, or to determine offers to be presented to the consumer 355a-355e. The compilation card 305 may also be used as an automated teller machine (ATM) card or debit card to retrieve cash from an ATM 399 that the consumer 355a-355e accumulated using the compilation card. The compilation card service provider 330 can also convert or exchange non-cash rewards, such as frequent flyer miles, into cash which can then be accessed through ATM 399 or used as a method of payment for merchandise through at a premium exchange rate over the Internet or when visiting a merchant. Special deals providing higher exchange rates for rewards earned through the use of the compilation card may be negotiated by the compilation card service provider 330 on behalf of the consumer 355a-355e.

The consumer 355a-355e and the compilation card service provider 330 can earn additional revenue by screening e-mail advertisements and offers received by vendors 396a, 396b, and allowing the e-mails to be forwarded to compilation card consumers 355a-355e via path 398 and the Internet 350. The vendors 396a, 396b can be required to pay a fee, which is shared by the compilation card service provider 330 and the consumer 355a-355e, in return for permitting the vendors' 396a, 396b e-mails to be sent to the consumer 355a-355e. The consumer 355a-355e may indicate in the consumer profile database 340 which type of offers the consumer 355a-355e is interested in and is willing to receive via e-mail for. The compilation card service provider 330 can either maintain the confidentiality of the consumer's current e-mail address and/or establish a new compilation card e-mail address solely for the purpose of generating revenue for the compilation card service provider 330 and the consumer 355a-355e. The compilation card service provider 330 also enables the consumer 355a-355e to designate compensation levels required before e-mail messages will be accepted for delivery. The consumer 355a-355e may specify different “prices” for different types of e-mail messages. The vendor may review the consumer's prices by visiting the website of the consumer's compilation card provider 330 or by using the consumer's account number to search a database (such as consumer credit card correlation database 400 shown in FIG. 4) established by the compilation card service provider 330. Thus, the privacy of the consumer 355a-355e is maintained.

FIG. 4 shows a consumer credit card correlation database 335 that includes the compilation card account number record 405 of each consumer using the compilation card 220, 305, a consumer profile identification (ID) field 410 used to access each compilation card consumer's profile, a plurality of credit card descriptions of the consumer's credit card accounts 415 (e.g., the type and issuer of each credit card), the associated (existing) credit card account numbers 420 and expiration dates 425, and supplemental information 430 about the consumer and/or the consumer's credit card accounts, such as credit card limits, consumer name, address and telephone number, or the like. The compilation card account number data 405 and consumer profile ID data 410 are provided by the compilation card service provider 330. All of the other information 415, 420, 425, 430 may be obtained from the consumer through the use of the Internet 350, telephone, mail or other well known communications means. The information may be obtained by prompting the consumer for particular information, or by hosting questionnaires that require a response from the consumer.

For example, account number “9909 8808 7707 6606” (i.e., the one card account) has consumer profile identification number “49,514” and four existing credit card accounts (Platinum Visa, “4305 8770 1234 5678” expiration date 03-03; Discover Platinum, account number “6011 0025 9876 5432”, expiration date 04-04; MasterCard, account number “5140 2100 3487 6543”, expiration date 07-02; and American Express, account number “3737 3213 4567 8910”, expiration date 09-01), associated therewith. Additionally, the supplemental information 430 associated with account number “9909 8808 7707 6606” can include the full name and address of the card holder, or as shown, “John Smith, 100 Oak Street, Anywhere, USA (555) 555-1234.”

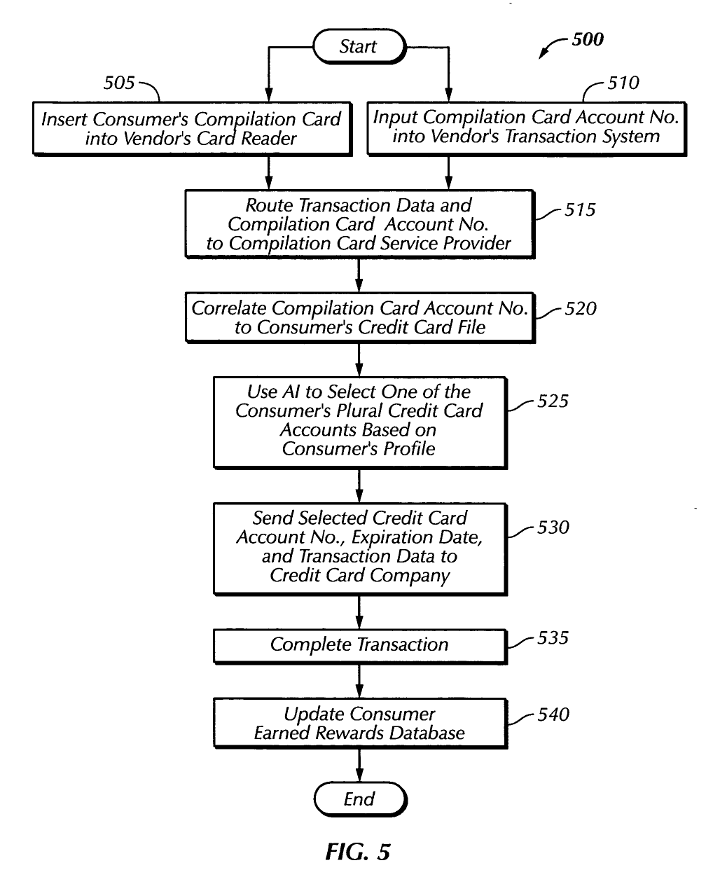

FIG. 5 shows a flow chart of a method implemented in accordance with preferred embodiments of the present invention. A consumer 355a-355e uses the compilation card 200, 305 to carry out a credit card transaction by inserting or having the vendor insert the compilation card 200, 305 into the vendor's card reader 310 (step 505). Alternatively, the compilation card account number 225 can be read off the surface of the compilation card 200, 305 and be manually inputted into the vendor's transaction system 315 (step 510), such as in the case where the compilation card 200, 305 is used to make purchases from the consumer's home via the Internet 350 or by telephone. Data regarding the particular transaction (e.g., amount charged) and the account number 225 of the compilation card 200, 305 is routed to the compilation card service provider 330 (step 515). The compilation card service provider 330 queries the consumer credit card correlation database 335 using the compilation card account number (step 520). Using artificial intelligence, the compilation card service provider 330 analyzes the credit card account information stored in the consumer credit card correlation database 335 and the consumer's profile stored in the consumer profile database 340, and compares rewards associated with the consumer's credit card accounts, from the various credit card companies 360, 365, 370, 375, with the predefined preferences and criteria established by the consumer (step 525). The compilation card service provider 330 continuously aggregates and updates rewards available to compilation card consumers 355a-355e in real-time. The compilation card service provider 330 then selects the one credit card account among the plurality of existing creditor card accounts that best meets the consumer's preferences and criteria and sends the selected credit card account number, expiration data and transaction data to the appropriate credit card company 360, 365, 370, 375 for processing (step 530). The transaction is then completed by the particular credit card company 360, 365, 370, 375 either approving or declining the transaction (step 535). The compilation card service database then immediately updates the consumer earned rewards database based on the completed transaction, such that the consumer can redeem the earned rewards without delay (step 540). While described here as the credit card company 360, 365, 370, 375 processes and approves/declines the transaction, the processing and approval/denial may be performed by a bank or other transaction processor. The compilation card service provider 330 ultimately passes the transaction information from the vendor 315 to the selected credit card company 360, 365, 370, 375 and passes the approval/denial from the selected credit card company 360, 365, 370, 375 to the vendor 315.

The consumer's preferences and criteria may include particular limitations to the monetary value of transactions and credit card balances for each registered credit card account. Thus, if the consumer's Bank of America® MasterCard account has a balance set by the consumer in the consumer profile database or correlation database that exceeds $4,500.00, the account would not be considered for future transactions using the compilation card 200, 305 even if there was sufficient credit to warrant additional purchases. Bank of America is a registered service mark of Bank of America Corporation, Charlotte, N.C.

The consumer's preferences and criteria could also be based on numerous other parameters such as a type of transaction, a vendor, a type of vendor, a time of the year when the compilation card is being used, a reward preference, and the like. The consumer's preferences and criteria may be obtained from the consumer through the use of the Internet, telephone, mail or other well known communications means. The consumer's preferences and criteria may be obtained by prompting the consumer for particular information, or by hosting questionnaires that require a response from the consumer.

In another embodiment of the present invention, the compilation card service provider 330 enables the consumer 355a-355e to be in charge of setting the price of access to personal information stored in the consumer profile database 340 or elsewhere. Individual prices may be set for small portions of the personal information. This enables the consumer 355a-355e to earn revenue and take charge of the distribution and accessibility provided to merchants of information such as economic, demographic, and even the consumer's identity, which as previously mentioned is not revealed on the surface of the compilation card 200, 305. Revenue earned through the use of the compilation card 200, 305 would be shared with the compilation card service provider 330 in accordance with a previously established agreement. The compilation card service provider 330 will be able to leverage the power of compilation card consumers 355a-355e with merchants that desire access to the consumer's personal information.

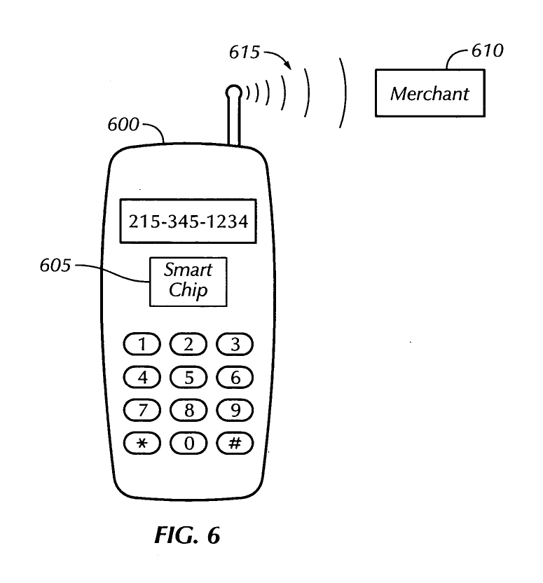

FIG. 6 shows a portable electronic device 600 that contains a smart chip 605 in accordance with a third preferred embodiment of the present invention. The portable electronic device 600 can be a cellular telephone, a wireless PDA, a wireless watch and the like. The portable electronic device 600 uses the smart 605 chip to select one of a plurality of credit card accounts to carry out any type of credit card transaction with a merchant 610 over a communications link 615. The consumer's identity is validated through the use of the smart chip 605 while maintaining the privacy of the consumer's identity. The smart chip 605 also contains information associated with the consumer's existing credit card accounts and sufficient artificial intelligence required to select one of the accounts to purchase any type of merchandise or service provided by the merchant 610.

In another embodiment of the present invention, the compilation card service provider 330 establishes an environment in which merchants have ample opportunity to generate new business and expand their customer base. Customers 355a-355e are drawn to a compilation card service provider 330 portal that provide convenient and extensive benefits and services to compilation card consumers, such as access to banks, bill payment services, investment houses, credit information, frequent flyer mileage, or the like. The compilation card service provider 330 portal is user-friendly and is accessible by laptops, personal digital assistants (PDAs), telephones, or the like. Compilation card consumers 355a-355e are also drawn to their individual websites to access offers sent by merchants. Merchants benefit by being exposed to a large consumer base which enhances their chances of procuring new customers.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

From the foregoing, it can be seen that the present invention is directed to a method and apparatus for monetizing personal consumer profiles by aggregating a plurality of consumer credit card accounts into one card. It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A computer-implemented method of using one of a plurality of existing credit card accounts belonging to a consumer, the method comprising:
providing account data to a single service provider for a plurality of existing credit card accounts belonging to the consumer;
providing the consumer with a compilation credit card associated with the plurality of existing credit card accounts of the consumer;
storing predefined preferences of the consumer regarding credit card selectivity;
the consumer performing a credit card transaction; and
selecting one existing credit card account among the plurality of existing credit card accounts to which to charge the credit card transaction based on the stored predefined preferences of the consumer.

2. The computer-implemented method according to claim 1, wherein the selection is performed using artificial intelligence to automatically determine which one existing credit card account to use based on the stored predefined preferences of the consumer.

3. The computer-implemented method according to claim 2, wherein the selection is also based on rewards currently being made available by the providers of the existing credit card accounts.

4. The computer-implemented method according to claim 1, wherein the compilation credit card is a portable electronic device having the plurality of existing credit card accounts of the consumer associated therewith, and
wherein the transaction step includes using the portable electronic device to perform the credit card transaction.

5. The computer-implemented method according to claim 4, wherein the portable electronic device is one of a cellular telephone, a wireless personal digital assistant (PDA) and a wireless watch.

6. The computer-implemented method according to claim 1, the predefined preferences of the consumer include one or more of a type of transaction, a vendor, a type of vendor, a time of the year when the compilation card is being used, a reward preference and a credit limit.

7. The computer-implemented method according to claim 1, wherein the compilation card includes a smart chip.

8. An apparatus that permits a consumer to access one of a plurality of existing credit card accounts belonging to the consumer, the apparatus comprising:
at least one credit card transaction network configured to route credit card transactions;
a compilation credit card being associated with the plurality of existing credit card accounts of the consumer, the compilation credit card having a compilation credit card number associated therewith; and
a compilation card service provider having a compilation card database that stores information for the plurality of existing credit card accounts belonging to the consumer and a consumer preferences database that stores predefined consumer preferences of the consumer, the compilation card service provider having access to the plurality of existing credit card accounts of the consumer, the compilation card service provider being accessible by the at least one credit card transaction network to receive credit card transaction requests based on the compilation credit card number and being configured to send credit card transaction approvals/denials,
one of the compilation credit card and the compilation card service provider being configured to select one existing credit card account among the plurality of existing credit card accounts to which to charge a particular credit card transaction based on the predefined preferences of the consumer.

9. The apparatus according to claim 8, wherein the compilation credit card is a portable electronic device being associated having the plurality of existing credit card accounts of the consumer associated therewith.

10. The apparatus according to claim 9, wherein the portable electronic device is one of a cellular telephone, a wireless personal digital assistant (PDA) and a wireless watch.

11. The apparatus according to claim 8, wherein the selection of the one existing credit card account is performed using artificial intelligence to automatically determine which one existing credit card account to use based on the predefined preferences of the consumer.

12. The apparatus according to claim 8, wherein the selection is also based on rewards currently being made available by providers of the existing credit card accounts.

13. The apparatus according to claim 8, wherein the predefined preferences of the consumer include one or more of a type of transaction, a vendor, a type of vendor, a time of the year when the compilation card is being used, a reward preference and a credit limit.

14. The apparatus according to claim 8, wherein the compilation card includes a smart chip.
